(19) United States
(12) Patent Application Publication
(10) Pub. No.: US 2004/0162028 A1
(43) Pub. Date: Aug. 19, 2004

(54) Short range radio link telephony information display

(76) Inventor: Kenneth Matthew Glover, Coppell, TX (US)

Correspondence Address: Steven Thrasher, 391 Sandhill Dr., Richardson, TX, 75080, US

(21) Appl. No.: 10/778,448

(22) Filed: Feb. 13, 2004

Related U.S. Application Data
(60) Provisional application No. 60/447,352, filed on Feb. 13, 2003.

(51) Int. Cl. H04M 3/42

(52) U.S. Cl. 455/41.2; 455/414.1; 455/415

(57) ABSTRACT

The invention teaches and shows systems, devices and methods for displaying telephony information across a short-range radio link. One preferred embodiment delivers caller identification (ID) information from a wireless telephone to a Bluetooth display device.

### RELATED APPLICATION

This invention is related to and claims priority from U.S. Provisional Patent Application No. 60/447,352 to Glover, filed on Feb. 13, 2003.

### TECHNICAL FIELD OF THE INVENTION

The invention relates generally to the field of short range radio links, such as Bluetooth.

### STATEMENT OF A PROBLEM ADDRESSED BY THIS INVENTION

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

### Discussion

Many persons are just beginning to enjoy the benefits of Bluetooth technology. For example, persons can send audio from a cell phone to a Bluetooth-enabled user headset. However, much additional beneficial functionality that may be created for Bluetooth systems has yet to be designed. Accordingly, there are benefits to be realized from delivering telephony information to a Bluetooth user. The present invention provides such apparatuses, systems and methods.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is one embodiment of a short range radio link telephony information display method; and

FIG. 2 illustrates one embodiment of a short range radio link telephony information display apparatus.

### AN EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way. In addition, statements that an aspect or element of the invention is obvious to one of ordinary skill in an art is applicable to only that specific art, and no other including the art of the invention, unless otherwise indicated.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Further, the discussion herein incorporates all known and foreseeable embodiments of the below-discussed devices, systems, apparatuses, means, and methods. Although modifications to this application may be required by the patent office, no such modifications are wavers of the doctrine of equivalents, or any other rights to equivalents in the invention.

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. The invention is also described in view of the Festo decisions, and, in that regard, the claims and the invention hereby expressly incorporate equivalents known, foreseeable, and unforeseeable, and all their equivalents in their entirety.

### Discussion of the Figures

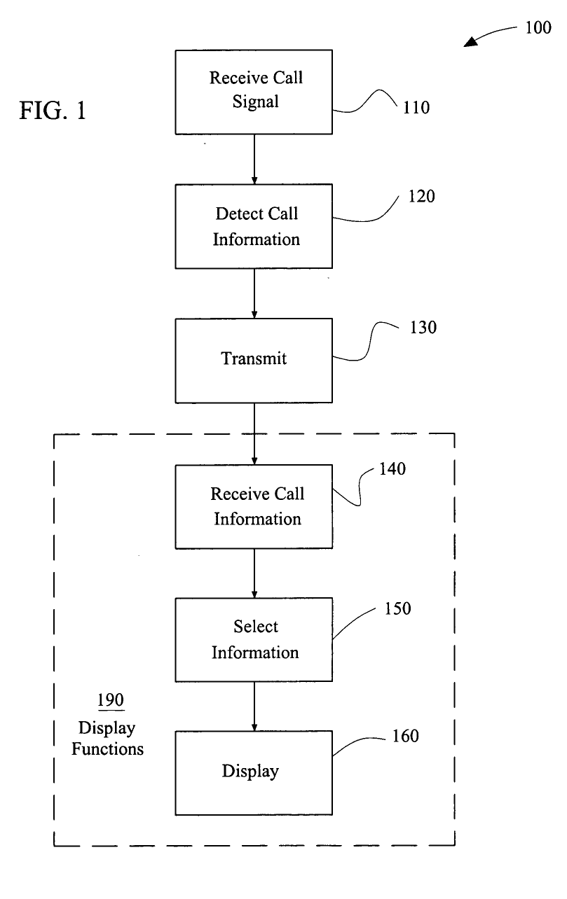

Features and advantages of the invention can be better understood by reviewing FIG. 1, which illustrates one embodiment of a method of displaying telephony information on a short range radio link apparatus via display functions 190. Typically, display functions 190 take place at or in a short range radio link apparatus (described below). Display functions 190 comprises an act of wirelessly receiving telephony information via a short range radio link at a short range radio link apparatus in a receive call information act 140. Telephony information includes information associated with a telephone call on a plain-old telephone system (POTS) or a cellular system or a satellite system, all of which are well-known systems in the telecommunications arts. Typically, the information is transmitted in a packetized format, where some predefined portion(s) of the packet comprise predefined information, such as call status, caller identification (including the alpha-numeric source of the call, often including a phone number and a name or word associated with the source of the call). Of course, other sources of information exist, and more specific methods of transmitting telephony information via wire line and wireless communication systems are well known in the telecommunications arts.

Short range radio links that provide networked functionality to electronic devices via defined standards. One new exemplary short range radio link, Bluetooth, is defined by standards that have been defined to provide networked functionality to electronic devices. Bluetooth standards are easily accessible via the internet and various standards organizations. It is foreseeable that other standards will be developed and these standards are included within the scope of the invention. A short range radio link apparatus is any apparatus adapted to send and/or receive a short range radio link signal, and is defined in further detail below.

Following the receive call information act 140, the method continues in a select information act 150, where the method selects at least a portion of the telephony information and identifies the information as selected information for display. Of course, the act 150 may select all, or any portion of, available telephony information for display. For example, selected information may include caller identification information, call status information, time of call, call receipt status, a message waiting status (in the event a message was left via “CallNotes™” or some other messaging system known in the telecommunication arts), a number of waiting messages, or any other information that is transmittable and displayable. Selecting includes user-selected information, pre-selected information, or dynamically selected information. In one embodiment the telephony signal has imbedded within it commands that are interpretable by the method, and one such command may select an information for display. Pre-selected information includes preselected default information, as well as information selected by a user interfacing with or installing the method. In one embodiment, the information includes text of a voice phone call.

After the select information act 150, the method continues in a display act 160. In the display act 160, the selected telephony information selected is displayed on the apparatus via a display screen, or vocalized via audio. Preferably, the selected information displayed includes a caller identification (caller ID) information, call status information, a telephone number, or other information associated with an incoming phone call, for example.

In one embodiment, a method may be operable on a system level as a telephony information display method 100, whereby the method further comprises first receiving the telephony information at a telephony apparatus in a receive call signal act 110. Common telephony apparatuses include common wire-line phones, mobile phones (either local or cellular network phones), and other devices known in the telecommunications art. After the receive call signal act 110, the method 100 proceeds to a detect call information act 120. In the detect call information act 120, telephony information is detected, and then some or all of the telephony information is selected for transmission via the short range radio link, and then actually transmitted via a transmit act 130. Of course, the disclosed method 100 is merely exemplary, and preferred. For example, it is not necessary that the detect call information act 120 be an “active” act—in other words it may be passive and allow all telephony information to be prepared for transmission, and not actively select information for transmission.

Though explained above, a method of displaying telephony information on a short range radio link apparatus 100 may be better understood via a general sequential discussion. Thus, the method may, in one embodiment may be said to include the act of receiving the telephony information at a telephony apparatus 110, detecting received telephony information in the detect call information act 120, the transmit act whereby telephony information is transmitted via a short range radio link 130, wirelessly receiving telephony information via the short range radio link at a short range radio link apparatus in the receive call information act 130, selecting at least a portion of the telephony information as selected information for display in the select information act 150, and displaying the selected information on the apparatus in the display act 160.

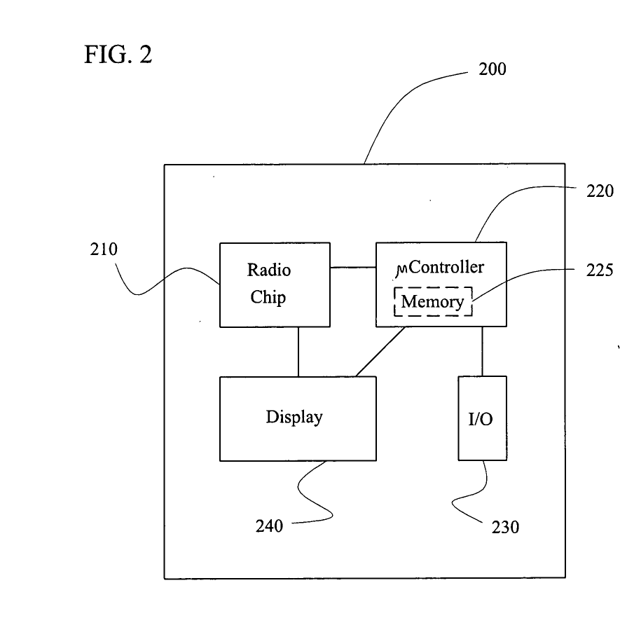

FIG. 2 illustrates one embodiment of a short range radio link telephony information display apparatus. The short range radio link apparatus generally comprises a form-factor 200, a short range radio link chip 210, a microcontroller 220 coupled to the chip 210, a display 240 coupled to the microcontroller 220, and memory coupled with the microcontroller 225. Preferred form factors include cases such as watches, pens, Bluetooth headset, and attachments thereto, for example. The radio link chip is preferably a Bluetooth-enabled radio chip, many of which are known to Bluetooth practitioners. Of course, the specific radio chip chosen will depend on the standard used for short range radio link communications. Similarly, many microcontrollers are known in the art, such as digital signal processors, including programmable digital signal processors.

Memory 225 may be integrated in the microcontroller 220, or located apart from the microcontroller. The memory 225 comprises computer code that enables a method of displaying telephony information on a short range radio link apparatus, such as preferably the above-disclosed methods. Of course, any method defined in the appended claims that enables the display of telephony information via a short range radio link is incorporated within the scope of the invention. In addition, an input/output (I/O) means 230 such as a Light Emitting Diode (other specific embodiments of which are well known in the electronic arts) is preferably coupled to the microcontroller 220. Further, the display is preferably a liquid crystal display, a plasma display, or a functional equivalent thereof. Of course, it is understood that many displays are known in the electronic arts, and others will be developed without departing from the scope of the invention.

Thus, though the invention has been described with respect to a specific preferred embodiment, many variations and modifications to the invention and to each element thereof will become apparent to those skilled in the art upon reading the present application. The language of the claims should be interpreted, unless otherwise indicated, as having the ordinary and plain meaning of the terms unless otherwise indicated. Therefore the appended claims are to be interpreted as broadly as possible in view of the prior art to include all such variations and modifications known, unknown, foreseeable and unforeseeable.

What is claimed is:

1. A method of displaying telephony information on a short range radio link apparatus, comprising:
wirelessly receiving telephony information via a short range radio link at a short range radio link apparatus;
selecting at least a portion of the telephony information as selected information for display; and
displaying the selected information.

2. The method of claim 1 wherein the short range radio link comprises a Bluetooth standard link.

3. The method of claim 1 wherein the telephony information comprises a caller identification information.

4. The method of claim 1 wherein displaying comprises displaying the phone number assigned to the incoming call telephony information.

5. The method of claim 1 wherein the telephony information comprises information associated with an incoming phone call.

6. The method of claim 1 further comprising first receiving the telephony information at a telephony apparatus.

7. The method of claim 6 wherein the telephony apparatus is a mobile phone.

8. The method of claim 6 further comprising detecting the telephony information, and selecting at least a portion of the telephony information for transmission.

9. The of claim 8 further comprising transmitting the selected telephony information via the short range radio link.

10. The of claim 6 further comprising transmitting the telephony information via the short range radio link.

11. The of claim 1 wherein the telephony information is selected telephony information.

12. The of claim 1 wherein the telephony information comprises call status information.

13. The of claim 1 wherein telephony information comprises a telephone number.

14. A method of displaying telephony information on a short range radio link apparatus, comprising:
receiving the telephony information at a telephony apparatus;
transmitting the telephony information via a short range radio link;
wirelessly receiving telephony information via the short range radio link at a short range radio link telephony information display apparatus;
selecting at least a portion of the telephony information as selected information for display; and
displaying the selected information on the short range radio link telephony information display apparatus.

15. The method of claim 1 wherein the short range radio link comprises a Bluetooth standard link.

16. The method of claim 1 wherein the telephony information comprises a caller identification information.

17. A short range radio link apparatus that displays telephony information, comprising:
a short range radio link chip;
a microcontroller coupled to the chip;
a display coupled to the microcontroller; and
memory coupled with the microcontroller, the memory comprising computer code that enables a method of displaying telephony information on a short range radio link apparatus, the method comprising
wirelessly receiving telephony information via a short range radio link at a short range radio link apparatus,
selecting at least a portion of the telephony information as selected information for display, and
displaying the selected information on the apparatus.

18. The apparatus of claim 17 wherein the apparatus comprises a Bluetooth headset form factor.

19. The apparatus of claim 17 wherein the apparatus comprises a watch form factor.

20. The apparatus of claim 17 wherein the apparatus comprises a pen form factor.
